(19) United States
(12) Patent Application Publication
(10) Pub. No.: US 2014/0338570 A1
(43) Pub. Date: Nov. 20, 2014

(54) CONCRETE MIX AND PRODUCTS INCLUDING RECYCLED PORCELAIN

(71) Applicant: Dale Paul Laurin, Appleton, WI (US)

(72) Inventor: Dale Paul Laurin, Appleton, WI (US)

(21) Appl. No.: 14/273,627

(22) Filed: May 9, 2014

Related U.S. Application Data
(60) Provisional application No. 61/823,630, filed on May 15, 2013.

(51) Int. Cl. C04B 18/16; C04B 28/02

(52) U.S. Cl. CPC C04B 18/165; C04B 28/021; C04B 2111/00965
USPC 106/706; 106/812

(57) ABSTRACT

A concrete mix for use in forming molded concrete end products is disclosed. The concrete mix includes treated porcelain kernels, cement and sand. The treated porcelain kernels are formed from recycled and currently unusable porcelain products. The porcelain products are crushed and processed to create porcelain kernels having a desired size. The porcelain kernels having the desired size are mixed with cement and sand and the concrete mix is packaged for subsequent use. The concrete mix including the porcelain kernels formed from recycled porcelain products allows the porcelain end products to be recycled while providing concrete products that have lighter weight and greater flame resistance.

### CROSS-REFERENCE TO RELATED APPLICATION

The present application is based on and claims priority to U.S. Provisional Patent Application Ser. No. 61/823,630 filed May 15, 2013, the disclosure of which is incorporated herein by reference.

### BACKGROUND

The present disclosure generally relates to a concrete mix that can be used in forming a variety of molded end products. More specifically, the present disclosure relates to a concrete mix that is formed including at least a portion of recycled porcelain, which can include pre-consumer and post-consumer porcelain.

Porcelain is a ceramic material made by heating raw materials including clay, glass and mullite at temperatures between 1200° C. and 1400° C. The toughness and strength of porcelain comes from the inclusion of glass and the mineral mullite within the fired body of the finished product. Porcelain as a finished product can be in many forms, including but not limited to, kitchenware such as sinks, vanity tops, and bathroom fittings such as tubs, sinks and commodes. Porcelain is an excellent dielectric and is the material of choice for high voltage insulators carrying cable/conductors where voltages can exceed 15,000 volts. Porcelain is also used in buildings in the form of tiles, signs and large translucent wall panels.

At the end of its life, porcelain is currently discarded and dumped into landfills. Recycling processes and end uses for recycled porcelain have not been developed for such a material. Thus, porcelain is generally considered unsalvageable and therefore unsellable. As a direct result, landfills are filled with materials that are not recyclable, which is certainly an undesirable condition given the limited space allowed for landfills.

As is well known in today's world, recycling is an established practice. For example, for our mineral assets and wood by-products, such as paper and cardboard, this practice is critical to maximize our natural resources. By contrast, we have been unable to recycle materials such as porcelain, since the composition of porcelain is clay, glass and mullite. Porcelain has a very high heat history that renders it unmalleable in any subsequent forming process.

The present disclosure is the result of experimentation with combinations of various materials and developing a process that incorporates a composition of previously unrecycled and unsellable post-consumer and post manufactured porcelain materials.

### SUMMARY

A new and heretofore unknown processing method has been developed that provides for the immediate consumption and reuse of porcelain materials from both post-manufacturing and post-consumer materials. Blend ratios of porcelain and other materials exceeding 65% have been achieved with the method of the present disclosure. A post-consumer concrete mix is disclosed consisting of sized granular porcelain kernels that are formed from crushed post-consumer and post-manufacturing finished porcelain materials such as sinks, vanity tops, and all unsalvageable reclaim from any manufacturing facility. The present disclosure also contemplates utilizing any porcelain product that cannot be used in the manner in which it was intended as a source to generate the porcelain kernels. As an example, a porcelain sink that was damaged in transit and cannot or will not be used as a sink any longer can be used as part of the method. The porcelain may be a pre-consumer or post-consumer product of any size, color, shape, or age.

The porcelain in its resized and treated form is blended with a customized cement and a customized sand slurry to form a countertop and/or any other concrete product, such as firewalls or other decorative and structural concrete products for use in residential and commercial applications.

The method of blending together of previously considered unsellable and unsalvageable materials to form a commercial and/or residential concrete products, such as a countertop, forms the basis of the present disclosure. The recycled material is porcelain, which is crushed from toilets, sinks, vanity tops, and any unsalvageable porcelain from a manufacturing facility. The porcelain supply can also include any porcelain product that cannot be used in the manner in was it was intended. As an example, a porcelain sink that was damaged in transit and cannot/will not be used as a sink any longer will be used as a supply of porcelain. The porcelain shall be a pre-consumer or post-consumer product of any size, color, shape, or age.

The concrete mix that includes the recycled porcelain can be used to form a wide variety of molded end products. Such end products, by example, can include countertops, custom moldings, such as flame retardant hearths, heat pads, and enclosures for fireplaces. The end products can also include roofing tiles, floor tiles and any other product currently being formed from molded concrete, building blocks, redi-mix concrete, wet/dry cast concrete, glass fiber reinforced concrete.

The present disclosure incorporates lightweight composition of materials using not less than 30% of post-consumer and post manufactured materials. In one embodiment of the disclosure, the concrete mix includes treated porcelain kernels that have a size in the range of 0.0117″ to 0.75″. The porcelain kernels are mixed with cement and sand and are provided as a pre-formed concrete mix. The pre-formed concrete mix can be blended with water and used to create any type of molded concrete product.

In accordance with the method of the present disclosure, a supply of post-consumer or post-manufactured porcelain is received at a recycling location. The supply of porcelain is processed at the recycling location to create a supply of porcelain kernels. The porcelain kernels are sorted and further processed such that the porcelain kernels have a preferred sizing in the range of 0.0117″ to 0.75″.

Once the porcelain kernels have been sorted and sized, the porcelain kernels are mixed with at least cement and sand to create a concrete mix. The concrete mix including the porcelain kernels created from recycled porcelain products is then packaged for later use in forming an end product.

This disclosure teaches a method and process of utilizing recycled porcelain as a component part of a materials mix including cement that may or may not include recycled fly ash, sand slurry, sized stones such as pea gravel, Portland cement and water.

The materials mix may be wet formed into numerous finished products including, but not limited to, such end products as countertops, fireplace surrounds and building blocks.

The inclusion of porcelain in material mixes as illustrated provides benefits including a significant weight reduction, greater flame retardancy, increased thermal insulating factors and R-values and a greatly improved and even mixture of the various components when the materials are wet formed. In addition to these benefits, the natural buoyancy and light weight of porcelain results in a more even disbursement of the porcelain kernels throughout the entire concrete end product which results in a more structurally sound and stronger end product compared to the use of pea gravel or buck shot as the aggregate. When the end product is polished, the evenly disbursed and exposed kernels provide for a more visually pleasing appearance for the end product as well.

### BRIEF DESCRIPTION OF THE DRAWINGS

The drawings illustrate the best mode presently contemplated of carrying out the disclosure. In the drawings:

FIG. 1 is a schematic view of a countertop created in accordance with the present disclosure;

FIG. 2 is a magnified, section view of the concrete formed utilizing the concrete mix of the present disclosure:

FIG. 3 is a section view illustrating a sample mold used to form a concrete countertop utilizing the concrete mix of the present disclosure:

FIG. 4 is a section view similar to FIG. 3 showing the disbursement of the porcelain kernels within the molded countertop: and

FIG. 5 is a flowchart illustrating the steps utilizing the method of the present disclosure.

### DETAILED DESCRIPTION

FIG. 1 illustrates one potential use for a concrete end product utilizing the concrete mix of the present disclosure. Although one type of concrete end product (countertops) is illustrated in FIG. 1, it should be understood that various different types of end products could be formed utilizing the concrete mix of the present disclosure. Theses concrete products can include both decorative and structural products that are typically formed from concrete.

In the embodiment shown in FIG. 1, the concrete mix is used to form a countertop 10 that can be installed in a kitchen 12. The countertop 10 includes a cutout that can receive a sink 14. The countertop 10 includes an edge surface 16 that is formed to provide a decorative and pleasing appearance.

Presently, it is known to form countertops 10 such as shown in FIG. 1 from various compositions of material that form concrete. Typically, concrete includes a mixture of sand, cement, water and an aggregate material, such as stone or pea gravel. In accordance with the present disclosure, the concrete mix used to form the countertop 10 includes a mixture of cement, sand, water and porcelain kernels formed from recycled porcelain end products.

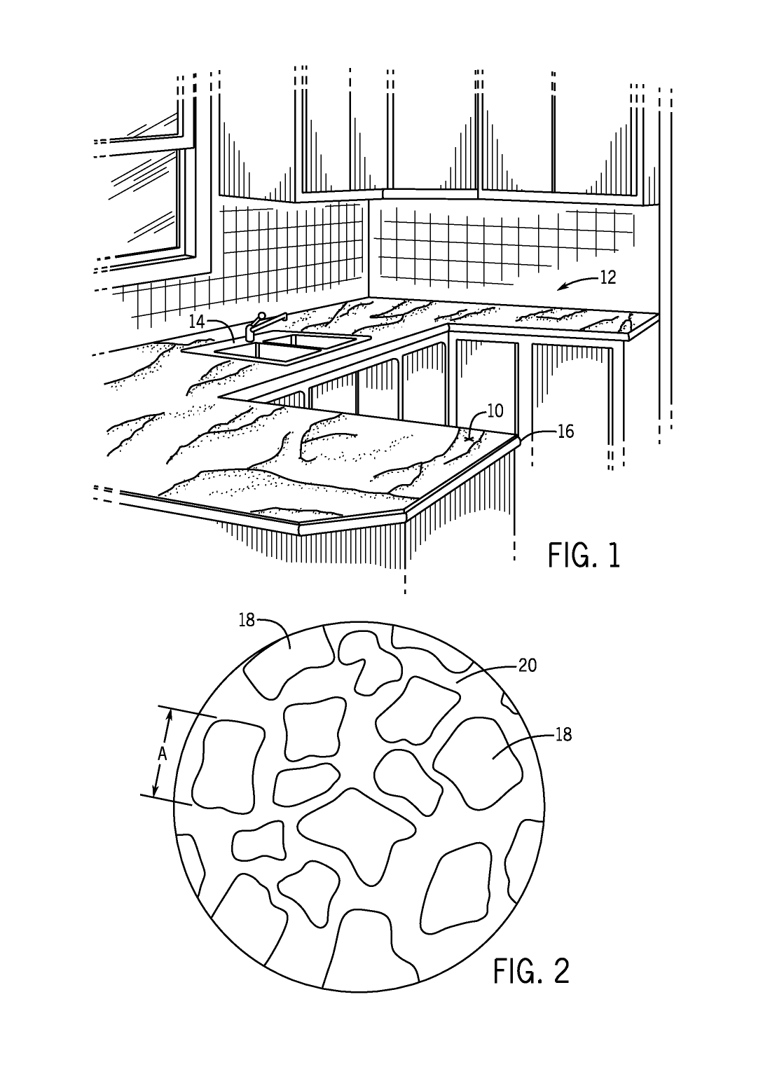

Referring now to FIG. 2, a section view of the concrete formed in accordance with the present disclosure includes the series of porcelain kernels 18 bound together by the mixture of cement, water and sand which forms the binding material 20 between the separate porcelain kernels 18. The porcelain kernels 18 are illustrated having irregular outer surfaces that are created during the crushing of porcelain end products that are being recycled to provide the source of porcelain for the concrete mix. The specific shape of the individual porcelain kernels 18 varies depending upon the processing techniques utilized and the source of recycled porcelain.

In accordance with the present disclosure, the porcelain kernels 18 are formed from porcelain products that are being recycled to create the concrete mix. Throughout the present disclosure, the term “recycled porcelain” will be used to refer to porcelain obtained from both post-consumer porcelain products as well as pre-consumer porcelain product or waste. As an example, a post-consumer porcelain product, such as a sink, vanity top, toilet or other similar type of porcelain product can be used to form the porcelain kernels 18. In addition to post-consumer porcelain products, the porcelain kernels 18 could also be generated from post-manufacturing, pre-consumer porcelain products that cannot be used in the manner which was intended. As an example, a porcelain sink that was damaged in transit or at the manufacturing facility and cannot be used as a sink could be utilized as a recycled supply to create the porcelain kernels 18. The porcelain used to create the porcelain kernels may be pre-consumer or post-consumer products of any size, color, shape or age.

In the embodiment shown in FIG. 2, the porcelain kernels are formed from recycled pre- or post-consumer products. It is desired that the porcelain kernels 18 have a size A shown in FIG. 1 in the range of 0.0117″ to 0.750″. In the most preferred embodiment, each of the kernels will be in the range of 0.265″ to 0.375″. The size of the porcelain kernels will affect the strength and durability of the concrete formed from the porcelain kernels 18 created from the recycled porcelain material. In the embodiment shown in FIG. 2, the countertop, or other molded product, formed from the concrete mixture that includes the porcelain kernels will have a weight savings of approximately 30% compared to similar commercial offerings for countertops, such as those formed from granite, marble, concrete, limestone, quartz or soap stone. In addition to the weight savings, an end product that is formed from the concrete mix including the porcelain kernels will increase the fire rating of the product by as much as 50% as compared to concrete formed with stone or pea gravel. The use of the porcelain kernels in the concrete shown in FIG. 2 creates a thermal break in the concrete unit's substrate, which leads to the increase in the fire rating.

In addition to being used as the source of aggregate in the concrete mix, it is contemplated that the recycled porcelain could be ground into very small pieces or particles such that the recycled porcelain would have the general consistency and texture of sand. In such an embodiment, the fine particle recycled porcelain could be used in the place of sand when forming concrete. Such an embodiment would increase the amount of recycled components in the concrete mix.

When a concrete product, such as a countertop, is formed from the concrete mix shown in FIG. 2, the countertop will qualify for the LEADS Program (Leadership In Energy And Environmental Design) through the U.S. Green Building Institute. The current qualification requires that the products must include a minimum of 20% post-consumer products or 50% post-industrial. The concrete mix in accordance with the present disclosure includes a minimum of 35% post-consumer products. The 35% post-consumer products include both recycled porcelain and cement that may or may not include recycled fly ash. Additional LEAD points will be given when the credit level requirements for the recycled content are exceeded, such as if the recycled porcelain and cement exceeds the 35% threshold.

In accordance with one embodiment of the present disclosure, the concrete mix includes porcelain kernels that constitute at least 35% of the mixture by weight. The concrete mix will include a mixture of the porcelain kernels, cement and sand. The porcelain kernels will form at least 35% of the mixture by weight.

In yet another embodiment that maximizes the amount of recycled components used in the concrete mix, a portion of the cement could be replaced with fly ash and the sand could be replaced with recycled porcelain ground into fine particles. Such an embodiment would increase the number of LEAD points.

When the concrete mix is used to form countertops, such as shown in FIG. 1, the countertop can be polished to expose the pores formed in the recycled porcelain kernels. The pores thus provide a visually pleasing appearance to the top surface of the countertop.

In addition to utilizing the concrete mix for countertops, such as shown in FIG. 1, it is contemplated that the concrete mix including the recycled porcelain could be utilized to form other end products, such as roofing tiles, vertical concrete columns or pillars, plaster mix, redi-mix, stucco, floor tiles and any other type of end product that is currently being formed from concrete that includes stone aggregate and/or sand. As described above, the concrete mix including the porcelain kernels will have approximately 35% less weight and thus can be utilized in applications in which the weight of a concrete product previously prohibited the use of concrete.

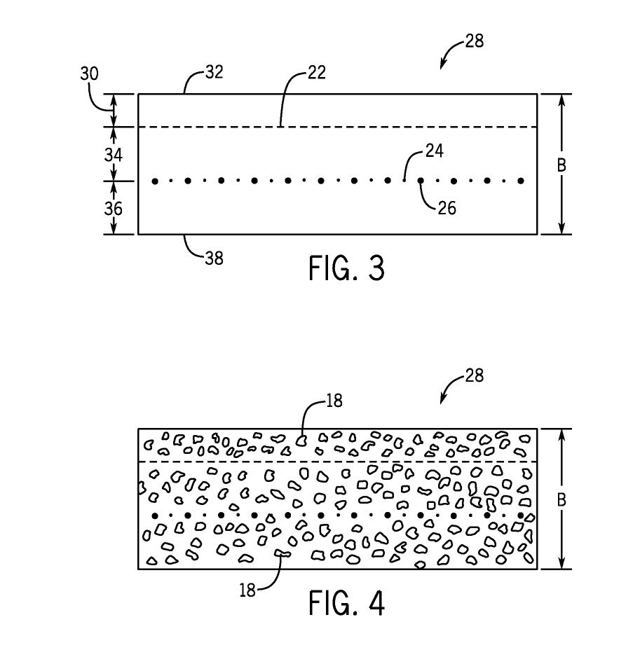

FIG. 3 illustrates a cross-section view of a countertop mold that will utilize the concrete mix of the present disclosure. In the embodiment shown in FIG. 3, an expanded metal/diamond mesh 22 is utilized within the concrete mold. In addition to the mesh 22, the mold can also include concrete wire 24 and rebar 26 to provide further structural integrity for the product formed from the concrete mix. In the embodiment shown in FIG. 3, the concrete wire has 6″×6″ openings or smaller and the wire has a diameter of between ⅛″ and 3/16″. In the embodiment illustrated, ⅜″ rebar 26 is included for structural purposes. However, it is contemplated that the rebar 26 could be eliminated while operating within the scope of the present disclosure.

In the embodiment shown in FIG. 3, the product 28 has an overall thickness B of approximately 1.75″ at a minimum. The product 28 has a first layer 30 between the top surface 32 and the mesh 22. In the embodiment shown, the top layer 30 has a thickness of approximately 0.50″. An intermediate layer 34 formed between the mesh 22 and the rebar 26 has a thickness of approximately 0.75″ while a third layer 36 between the rebar 26 and the bottom surface 38 has a thickness of approximately 0.50″Although exemplary dimensions are shown in the embodiment of FIG. 3, it should be understood that the thickness of the product 28 could be varied depending upon user requirements.

FIG. 4 illustrates the product 28 as including the porcelain kernels 18 distributed throughout the thickness of the product. The porcelain kernels 18 are balanced and equally distributed throughout the thickness B of the end product 28. Each of the porcelain kernels 18, as previously discussed, is a fractured component and is not of a smooth, defined surface. The fractured outer surface of the porcelain kernels 18 enhances the adhesion of the cement within the concrete mix.

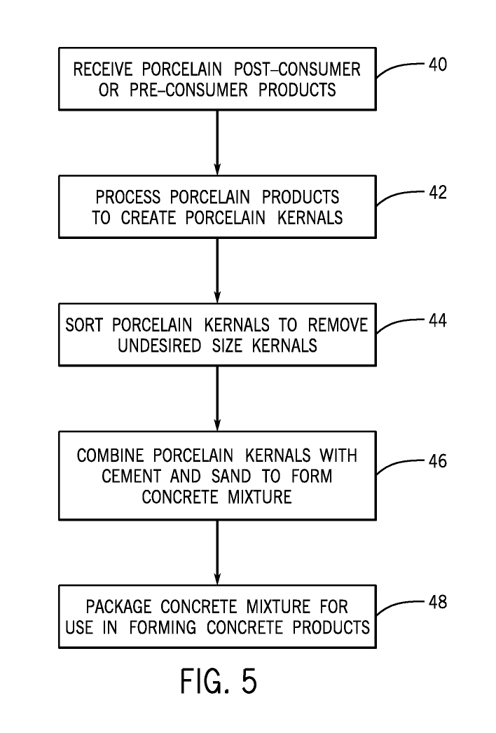

FIG. 5 illustrates one method of creating the concrete mix in accordance with the present disclosure. As illustrated in FIG. 5, the method first includes the step of receiving recycled post-consumer and/or pre-consumer porcelain products, illustrated by reference numeral 40. The post-consumer products can include various different types of finished materials formed from porcelain, such as sinks, vanity tops, toilets or any other type of product that is formed from porcelain. Although step 40 shows the use of post-consumer and pre-consumer products, it should be understood that any other porcelain product that is currently undesirable and is being discarded could be utilized. As an example, pre-consumer products, such as a sink that is damaged in transit or during the manufacturing process and can no longer be used for its intended purpose, could be part of the porcelain products received in step 40.

Once the porcelain products being recycled and received in step 40, the porcelain products are processed to create porcelain kernels. Typically, this processing will include crushing and breaking of the consumer product that is formed from porcelain. During this processing step 42, the porcelain products are crushed until the kernels reach a desired kernel size. In step 42, the method sorts the kernels such that kernels smaller than a desired size and those larger than a desired size are discarded. Kernels that have a size too large are returned for further processing while kernels of a size less than a minimum are discarded for other use. As discussed previously, the desired size for the porcelain kernels is in the range of 0.0117″ to 0.750″. The most preferred size range for the porcelain kernels is in the range of 0.265″ to 0.375″.

Once the desired porcelain kernel sizes have been separated, the porcelain kernels are combined with cement and sand to form the concrete mix, as shown in step 46. Although a concrete mix is described as including sand, the mix could be formed without sand and could incorporate very fine particles of recycled porcelain. As indicated above, it is desired that the porcelain kernels form at least 35% of the concrete mixture. Further, the concrete mix can also include a cement/fly ash mixture that further increases the recycled components of the concrete mix. In an embodiment in which both the porcelain kernels and cement/fly ash are drawn from recycled products, it is desirable that the combination of the porcelain and the recycled cement/fly ash constitute at least 65% of the mix by weight.

Once the concrete mix is formed in step 46, the concrete mix is packaged in step 48 for use in forming concrete products. The packaging step 48 can place the concrete mix into 50 lb. bags, or any other size as desired. Alternatively, the packaging step can be eliminated and the concrete mix used immediately to form concrete products, such as countertops.

Once the concrete mix has been packaged, the concrete mix can be shipped or sold to concrete countertop manufacturers and installers for the creation of concrete countertops having a desired shape and size. The concrete mix can be dyed or colored to meet any decorative look for a home or business owner.

In addition to utilizing the concrete mix for forming countertops, it is understood that the concrete mix could be utilized to form many other different types of decorative and structural concrete products while operating within the scope of the present disclosure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A pre-formed concrete mix for use in forming end products, comprising:
treated porcelain kernels formed from recycled porcelain;
cement; and
sand.

2. The concrete mix of claim 1 wherein the treated porcelain kernels have a size in the range of 0.0117″ to 0.75″.

3. The concrete mix of claim 2 wherein the treated porcelain kernels have a most preferred sizing in the range of 0.265″ to 0.375″.

4. The concrete mix of claim 1 wherein the cement includes fly ash and at least 30% of the concrete mix by weight is from recycled porcelain and fly ash.

5. The concrete mix of claim 1 wherein the sand is formed from recycled porcelain.

6. The concrete mix of claim 1 wherein the treated porcelain kernels constitute at least 35% of the concrete mix by weight.

7. The concrete mix of claim 5 wherein the treated porcelain kernels constitute at least 35% of the concrete mix by weight.

8. A method of forming a concrete mix, comprising the steps of:
receiving a supply of recycled porcelain:
processing the porcelain to create finished porcelain kernels;
mixing the finished porcelain kernels with at least cement and sand to create the concrete mix; and
packaging the concrete mix for use in forming an end product.

9. The method of claim 8 wherein the porcelain kernels have a size in the range between 0.0117″ to 0.750″.

10. The method of claim 9 wherein the treated porcelain kernels have a most preferred sizing between 0.265″ and 0.375″.

11. The method of claim 8 wherein the treated porcelain kernels constitute at least 35% of the concrete mix by weight.

12. The method of claim 8 wherein the cement includes fly ash and at least 30% of the packaged concrete mix by weight is formed from recycled porcelain and fly ash.

13. A packaged concrete mix for use in forming countertops, comprising:
treated porcelain kernels, at least a portion of which are formed from recycled porcelain products;
cement; and
sand.

14. The concrete mix of claim 13 wherein the treated porcelain kernels have a size in the range of 0.0117″ to 0.750″.

15. The concrete mix of claim 14 wherein the treated porcelain kernels have a sizing in the most preferred range of 0.265″ to 0.375″.

16. The concrete mix of claim 13 wherein at least 30% of the concrete mix by weight is formed from recycled porcelain and recycled cement.

17. The concrete mix of claim 13 wherein the treated porcelain kernels constitute at least 35% of the concrete mix by weight.

18. The concrete mix of claim 13 wherein the sand is formed from recycled porcelain.
